(19) United States
(12) Patent Application Publication
(10) Pub. No.: US 2022/0385485 A1
(43) Pub. Date: Dec. 1, 2022

(54) IDENTITY THEFT PROTECTION WITH NO PASSWORD ACCESS

(71) Applicant: Micron Technology, Inc., Boise, ID (US)

(72) Inventor: Zhan Liu, Cupertino, CA (US)

(21) Appl. No.: 17/335,914

(22) Filed: Jun. 1, 2021

(51) Int. Cl. H04L 9/32; H04L 9/08

(52) U.S. Cl. CPC H04L 9/3278; H04L 9/3247; H04L 9/0894; H04L 9/3268

(57) ABSTRACT

The disclosed embodiments relate to using a memory device as a personal identification device. In one embodiment, a method is disclosed comprising receiving a message from a host processor; loading a private key, the private key generated based on a unique value generated by a physically unclonable function (PUF); signing the message using the private key to generate a signed message, and returning the signed message to the host processor.

### TECHNICAL FIELD

At least some embodiments disclosed herein relate to memory devices in general, and more particularly, but not limited to utilizing a secure memory device to prevent identity theft without password requirements.

### BACKGROUND

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 is a block diagram of a memory device according to some embodiments of the disclosure.

FIG. 2 is a flow diagram illustrating a method for generating a key pair according to some embodiments of the disclosure.

FIG. 3 is a flow diagram illustrating a method for signing messages according to some embodiments of the disclosure.

FIG. 4 is a flow diagram illustrating a method for establishing a secure channel according to some embodiments of the disclosure.

FIG. 5 is a block diagram illustrating a memory system according to some embodiments of the disclosure.

FIG. 6 is a block diagram illustrating a computing device showing an example of a client or server device used in the various embodiments of the disclosure.

### DETAILED DESCRIPTION

In the following embodiments, a memory device can operate as a personal identifier device (PID). When a user obtains (e.g., purchases) a PID, a digital certificate is generated with the user's personal info as a common name (e.g., a CN field in an X.509 certificate), which indicates that the user is the owner of the public key. In some embodiments, the user provides government identification (e.g., a passport or driver's license) to register the information.

In the embodiments, a PID can comprise a memory device such as a NAND Flash drive that can include firmware or other logic to generate and re-generate a public/private key pair from a physical unclonable function (PUF) without the need to store the private key upon powering down. Thus, the private key is secured in the device as a secret and can represent the identity of the owner of the device.

In some embodiments, the PID can generate a public/private key pair (e.g., in response to a command, automatically on boot, etc.) using the PUF. The PID can write the public/private key pair to a secure (e.g., write-protected) location in a storage array. In one embodiment, the PID can write the public portion of the key pair to a write-protected region while writing the private key portion to a confidential/inaccessible storage location. In some embodiments, the private key need not be written to storage at all. The PID can then register the public key of a key pair with a Certificate Authority (CA). When registering, the PID can associate the public key with the owner of the device. In response, the PID can receive and store a digital certificate generated by the CA. In some embodiments, the PID can communicate directly with a CA. In other embodiments, an intermediary device (e.g., a host processor) can be configured to communicate with the CA. In some embodiments, the above process is performed by a manufacturer prior to distribution (e.g., sale) of the PID. Thus, when purchasing the PID, the customer provides its identifying information (e.g., data from a license, company identifier, etc.), and the manufacturer generates a unique identifier. These two data points can be used as the data in, for example, a CN field of the certificate signing request (CSR). In some embodiments, the key pair generated using this process comprises the PID device identity keys.

In some embodiments, the PID can receive a message from, for example, a host processor. For example, the PID can expose an API that allows an application running on the host processor to submit a message (e.g., an email, a payment request, a login request) and obtain a digital signature that can be verified and/or authenticated via the public key and CA. In response to the message, the PID can load or generate a private key. Since a PUF is used, the PID may not need to permanently store the private key. If a new key is generated, it can be signed by the device identity key and form a CA key chain (e.g., since the device identity key is signed by a trusted CA). The CN of the new key CA can thus have an owner's alternative identity, such as email, website account username, etc. Therefore, the owner can access different servers with different keys and/or identities. The PID can then sign the message using the private key. In one embodiment, the PID uses an Elliptic Curve Digital Signature Algorithm (ECDSA), but other algorithms may be used. Thus, the signature of such a device can be used to authenticate the origin of the message.

A client device with a PID initiates a transport layer security (TLS) session with a server. During a TLS handshake, the client device receives a request for a digital certificate and transmits the digital certificate to the server. In some embodiments, the server may use the digital certificate to identify a user account. If no account is found, the server may generate an account automatically. The client device can also confirm the server's identity by verifying the server's digital certificate.

In the illustrated embodiment, the only client registration is CA-based on the PID upon purchase. Then, any server (e.g., financial institution, workplace, school, etc.) can grant access to the client device equipped with the PID based on the digital certificate stored by the PID. In this manner, identity theft is prevented via cryptographic security. Further, a server supporting the embodiments does not need to save a salted password (e.g., a hash of a password) to verify the password, which increases the security of the system.

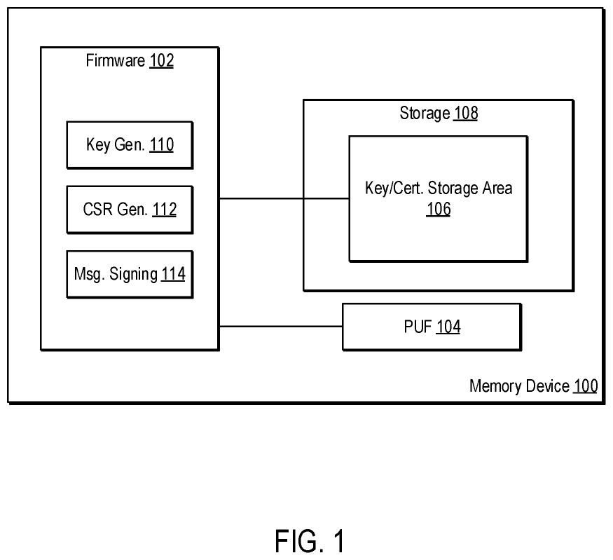

FIG. 1 is a block diagram of a memory device according to some embodiments of the disclosure.

In an embodiment, a memory device (100) can comprise a non-volatile memory device such as a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD).

In an embodiment, the memory device (100) includes a storage medium (108). In an embodiment, a storage medium (108) can comprise an array of memory cells. In one embodiment, a storage medium (108) can comprise an array of NAND Flash cells. One type of memory cell, for example, single-level cells (SLC), can store one bit per cell. Other types of memory cells, such as multi-level cells (MLCs), triple-level cells (TLCs), quad-level cells (QLCs), and penta-level cells (PLCs), can store multiple bits per cell. In some embodiments, the storage medium (108) can include one or more arrays of memory cells such as SLCs, MLCs, TLCs, QLCs, PLCs, or any combination of such. In some embodiments, a memory device (100) can include an SLC portion, an MLC portion, a TLC portion, a QLC portion, and/or a PLC portion of memory cells. The memory cells of the storage medium (108) can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 100 can be based on any other type of non-volatile memory, such as read-only memory (ROM), phase-change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, electrically erasable programmable read-only memory (EEPROM), etc.

In an embodiment, the storage medium (108) includes a key and certificate storage area (106). In an embodiment, the key and certificate storage area (106) can comprise a write-protected region of storage medium (108). In another embodiment, the key and certificate storage area (106) can comprise a physically separate storage area of the storage medium (108). In some embodiments, the key and certificate storage area (106) can comprise a volatile storage area. In one embodiment, the key and certificate storage area (106) can comprise separate storage areas for keys and certificates. In such an embodiment, the storage area for keys can be volatile storage, while the storage area for certificates can comprise non-volatile storage.

In an embodiment, memory device (100) includes a physically unclonable function, PUF (104). In the illustrated embodiment, the PUF (104) may comprise a physical hardware circuit that exploits inherent randomness introduced during manufacturing to give a physical entity a unique ‘fingerprint’ or trust anchor. In the illustrated embodiment, the PUF (104) produces a consistent and repeatable value. In some embodiments, the PUF (104) may comprise an SRAM PUF, Delay PUF, or any other PUF technology implemented on the memory device (100).

In the illustrated embodiment, memory device (100) includes firmware (102). In the illustrated embodiment, firmware (102) can be stored in a dedicated storage device such as read-only memory (ROM), erasable programmable ROM (EPROM), electrically erasable programmable ROM (EEPROM), or Flash (NAND or NOR) memory. In the illustrated embodiment, the firmware (102) implements various functions, including, but not limited to, key generation logic (110), certificate signing request logic (112), and message signing logic (114). Certainly, firmware (102) can implement additional functions such as lower-level hardware control functions. These additional functions are not described in detail for the sake of clarity.

In the illustrated embodiment, key generation logic (110) comprises executable code and/or dedicated hardware circuitry to generate an asymmetric key pair. In the illustrated embodiment, the key generation logic (110) reads a value from PUF (104) and uses this value to generate a public/private key pair. In some embodiments, the key generation logic (110) can generate a public/private key pair using an asymmetric or public-key cryptosystem. For example, a Rivest-Shamir-Adleman (RSA) or Elliptic Curve Cryptography (ECC) key generation algorithm can be used to generate public/private key pairs. In the illustrated embodiment, the value generated by the PUF (104) can replace a random number used to generate a public/private key pair. Specifically, the value generated by the PUF (104) can be used to seed the key generation logic (110). After seeding using the PUF (104) value, the key generation logic (110) can implement any asymmetric key generation algorithm to generate a public/private key pair.

In an embodiment, key generation logic (110) can write the public/private key pair to key and certificate storage area (106). In an embodiment, key generation logic (110) can write the public key to a non-volatile portion of the key and certificate storage area (106). In an embodiment, key generation logic (110) can write the private key to a volatile portion of the key and certificate storage area (106). In some embodiments, key generation logic (110) can only write the public key to the key and certificate storage area (106) and may not write the private key to the key and certificate storage area (106). In such an embodiment, key generation logic (110) may only store the private key in a register or similar temporary storage location. In one embodiment, since the key generation logic (110) uses the value of the PUF (104), key generation logic (110) can faithfully re-generate public/private key pairs on demand and thus is not required to store keys for use in downstream applications. Thus, in some embodiments, key generation logic (110) may not persist either the public or private keys to a non-volatile storage location. In one embodiment, the key pairs generated by key generation logic (110) can comprise device identity keys. In one embodiment, the device identity keys can be used as a root of trust in a layered cryptographic identity system such as a Device Identifier Composition Engine (DICE) or similar architecture.

In the illustrated embodiment, certificate signing request logic (112) comprises executable code and/or dedicated hardware circuitry to generate a certificate signing request (CSR) and transmit a CSR to a certificate authority (CA). In some embodiments, certificate signing request logic (112) can further be configured to receive a digital certificate from the CA and write the CA to key and certificate storage area (106). In one embodiment, certificate signing request logic (112) can generate a CSR formatted according to a defined standard such as PKCS #10. In an embodiment, certificate signing request logic (112) includes the public key generated by key generation logic (110) in the CSR. In an embodiment, the certificate signing request logic (112) further includes an identifier of a user in the CSR. For example, in a PKCS #10 CSR, the certificate signing request logic (112) can include an identifier of the user in the common name (CN) field of the PKCS #10 CSR.

In one embodiment, certificate signing request logic (112) generates the CSR when a user purchases a memory device (100). For example, the certificate signing request logic (112) can be executed by a manufacturer prior to being released to a customer. When a customer purchases the memory device (100), it can provide identifying information (e.g., company name, driver's license, passport, etc.). No limit is placed on the type of information that can be used to identify a user so long as the information can be used to identify the user of the memory device. In response, the manufacturer executes the certificate signing request logic (112) to generate the CSR using the identifying information of the user as well as the public key that is unique to the memory device (100).

The certificate signing request logic (112) then transmits the CSR to a CA. In one embodiment, the memory device (100) can transmit the CSR directly to the CA. In this embodiment, the memory device (100) can include a network interface to allow for network communications. In another embodiment, an intermediary device (e.g., a host processor) can be used to facilitate communications with the CA.

The certificate signing request logic (112) receives a digital certificate generated by the CA in response to the CSR. In an embodiment, the digital certificate can comprise an X.509 certificate issued by a trusted CA. In response, the certificate signing request logic (112) stores the digital certificate in the key and certificate storage area (106). In an embodiment, the certificate signing request logic (112) can write the digital certificate to a write-protected region of key and certificate storage area (106).

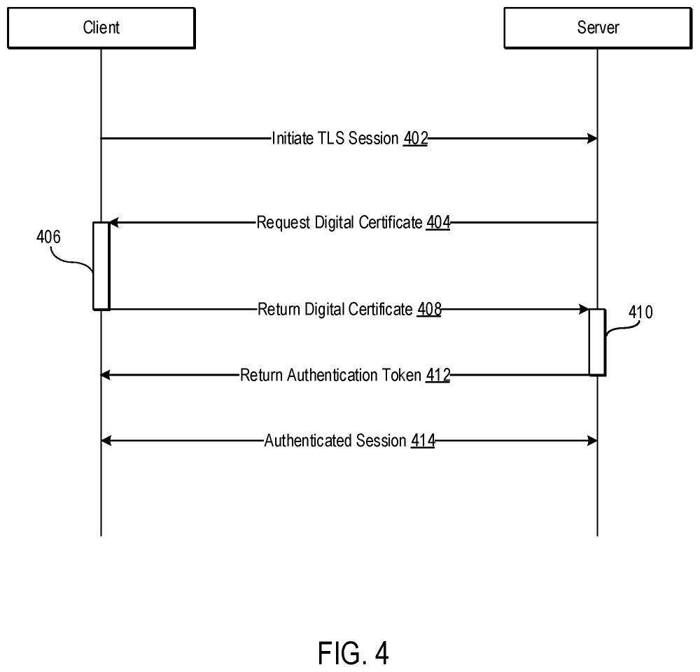

In the illustrated embodiment, message signing logic (114) comprises executable code and/or dedicated hardware circuitry to sign messages received from, for example, a host processor (not illustrated). In an embodiment, a memory device (100) can expose an application programming interface (API) that allows the host processor to request the signing of messages by the memory device (100). No limit is placed on the type of messages that the memory device (100) can receive via the API. Examples of messages include emails, payment requests, login requests, etc.). In response to a message, the message signing logic (114) can generate a digital signature based on the message. In an embodiment, the message signing logic (114) can utilize a digital signature algorithm such as RSA or ECDSA to generate a digital signature for a message. In an embodiment, the message signing logic (114) uses the private key generated by key generation logic (110) to generate a digital signature. The specific details of the digital signature algorithm are not limiting, and various other digital signature algorithms can be used. After generating the digital signature, the message signing logic (114) returns the digital signature to the calling device (e.g., host processor). In one embodiment, the public key generated by key generation logic (110) can be provided to the calling device (e.g., host processor) and thus used in, for example, a TLS session, as described in FIG. 4.

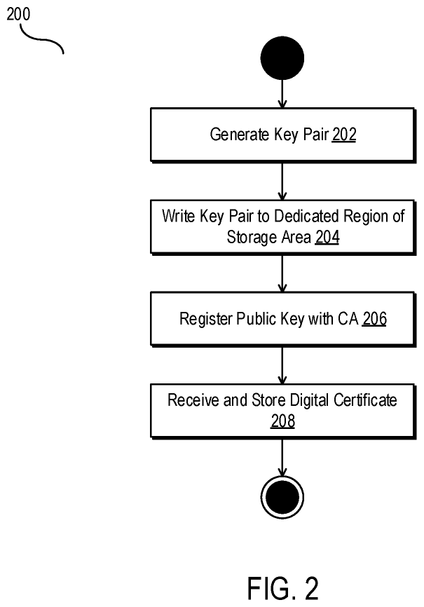

FIG. 2 is a flow diagram illustrating a method for generating a key pair according to some embodiments of the disclosure.

In block 202, method 200 can include generating a key pair.

In an embodiment, the key pair comprises an asymmetric public/private key pair. In an embodiment, method 200 reads a value from a PUF and uses this value to generate a public/private key pair. In some embodiments, method 200 can generate a public/private key pair using an asymmetric or public-key cryptosystem. For example, an RSA or ECC key generation algorithm can be used to generate public/private key pairs. In the illustrated embodiment, the value generated by the PUF can replace a random number used to generate a public/private key pair. Specifically, the value generated by the PUF can be used as a seed prior to generating the key pair. After seeding using the PUF value, method 200 can implement any asymmetric key generation algorithm to generate a public/private key pair. In one embodiment, method 200 can execute block 202 in response to a command received from an external device (e.g., host processor). Alternatively, or in conjunction with the foregoing, method 200 can execute block 202 automatically on starting up or powering on.

In block 204, method 200 can write the key pair to a dedicated region of a storage area.

In an embodiment, method 200 can write the public key to a non-volatile portion of a storage area. In an embodiment, method 200 can write the private key to a volatile portion of the storage area. In some embodiments, method 200 may only write the public key to the storage area and may not write the private key to the storage area. In such an embodiment, method 200 may only store the private key in a register or similar temporary storage location. In one embodiment, the dedicated region of the storage area can comprise a write-protected region of the storage area. In one embodiment, since method 200 uses the value of the PUF, method 200 can faithfully re-generate public/private key pairs on demand and thus is not required to store keys for use in downstream applications. Thus, in some embodiments, block 204 can be optional.

In block 206, method 200 registers the public key of the key pair with a CA.

In the illustrated embodiment, registering the public key in block 206 comprises generating a CSR formatted according to a defined standard such as PKCS #10. In an embodiment, method 200 includes the public key generated in block 202 in the CSR. In an embodiment, method 200 includes an identifier of a user in the CSR. In one embodiment, method 200 generates the CSR when a user purchases a memory device implementing method 200. For example, method 200 can be executed by a manufacturer prior to being released to a customer. When a customer purchases a memory device, it can provide identifying information (e.g., company name, driver's license, passport, etc.). No limit is placed on the type of information that can be used to identify a user so long as the information can be used to identify the user of the memory device. In response, the manufacturer executes method 200 to generate the CSR using the identifying information of the user as well as the public key that is unique to the memory device. In an embodiment, registering the public key further comprises transmitting the CSR to a CA over a network such as the Internet.

In block 208, method 200 receives and stores a digital certificate received from the CA.

In an embodiment, method 200 receives a digital certificate generated by the CA in response to the CSR. In an embodiment, the digital certificate can comprise an X.509 certificate issued by a trusted CA. In response, method 200 stores the digital certificate in the dedicated region of a storage area as discussed in block 204.

As a result, at the conclusion of method 200, a memory device executing method 200 can persistently store a secure digital certificate that is unique tied to both the memory device (via the PUF-based public key) and a specific user or organization (via the common name field of the certificate).

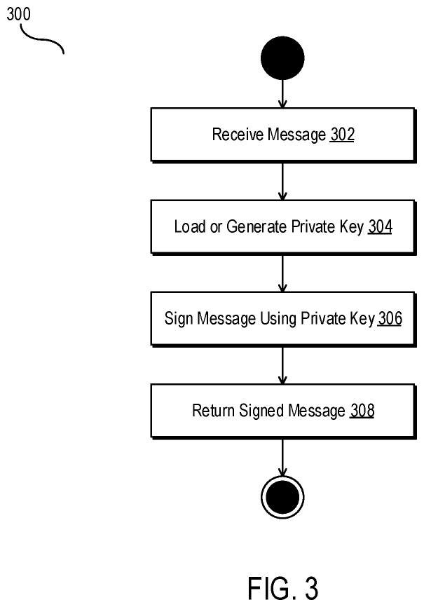

FIG. 3 is a flow diagram illustrating a method for signing messages according to some embodiments of the disclosure.

In block 302, method 300 can include receiving a message.

In an embodiment, method 300 receives a message from an external device such as a host processor. In an embodiment, method 300 is executed by the firmware of a memory device. In an embodiment, method 300 can expose an application programming interface (API) that allows the host processor to request the signing of messages. No limit is placed on the type of messages that method 300 can receive. Examples of messages include emails, payment requests, login requests, etc.).

In block 304, method 300 can include loading or generating a private key.

In an embodiment, method 300 can load a private key from a dedicated area of a storage array such as a confidential/inaccessible storage location. In one embodiment, the PID can write the public portion of the key pair to a write-protected region while writing the private key portion to a confidential/inaccessible storage location. In some embodiments, the private key need not be written to storage at all. In such embodiments, method 300 can automatically generate a private key using, for example, block 202 of FIG. 2. Since the public/private key pair is generated using a PUF, the key pair (and thus private key) can be arbitrarily re-generated as needed. As such, a memory device executing methods 200 and 300 need not persistently store a private key and can thus ensure the security of the private key since the private key can be removed upon power off.

In some embodiments, method 300 can comprise generating a second public/private key pair, the second public/private key pair different from that generated in block 202. In these embodiments, the public/private key pair is referred to as a derived key. In an embodiment, the derived private key can be signed by the device identity key generated in block 202 and can form a CA key chain (since the device identity key is signed by a trusted CA). The CN of the new key CA can have an owner's other identity, such as email, etc. Therefore, a given owner can access different servers with different keys and identities.

In block 306, method 300 can include signing the message using the private key.

In response to a message, method 300 can generate a digital signature based on the message. In an embodiment, method 300 can utilize a digital signature algorithm such as RSA or ECDSA to generate a digital signature for a message. The specific details of the digital signature algorithm are not limiting, and various other digital signature algorithms can be used.

In block 308, method 300 can include returning the signed message.

In an embodiment, after generating the digital signature, method 300 returns the digital signature to the calling device (e.g., host processor). In an embodiment, the public key can be provided to the calling device (e.g., host processor) and thus used in, for example, a TLS session, as described in FIG. 4.

In these embodiments, a memory device (e.g., Flash device) can be used as a message signing co-processor that can sign any arbitrary message. Since the cryptographic aspects (e.g., public/private key pair, certificate, etc.) are secured in the memory device and not exposed to sideband or laboratory attacks, the security of the message signing process can be guaranteed.

FIG. 4 is a flow diagram illustrating a method for establishing a secure channel according to some embodiments of the disclosure. In the illustrated embodiments, a client communicates with a server. In the illustrated embodiments, the client can include a PID such as a memory device depicted in FIG. 1 and capable of the operations discussed in connection with FIGS. 2 and 3.

In block 402, the client initiates a TLS session. In one embodiment, the initiation of the TLS session can be performed as part of a secure HTTP (HTTPS) request, although the disclosure is not limited in this manner. Internal details of initiating a TLS (or similar protocol) session are not described in detail herein.

In one embodiment, block 402 comprises completing a three-way transport control protocol (TCP) handshake between the client and server. The client then sends various details describing its TLS capabilities, such as the TLS version implemented, supported cipher suites, and any other relevant TLS options. The server then selects a supported TLS version and cipher suite and responds with the selected version and cipher suite. The server can also include its own digital certificate.

In block 404, the server requests a digital certificate from the client.

Notably, in the illustrated embodiment, the server can also request that the client provide its own digital certificate. In one embodiment, the server can request the client's digital certificate via a Certificate Request message according to Request for Comments (RFC) 5246 or similar standards. In some embodiments, the server is specifically configured to request a client certificate. Thus, if the client connects to a second server that is not configured, the client will not provide a digital certificate to the server. In some embodiments, after requesting the digital certificate in block 404, the server can complete the server response to a client-initiated TLS session.

In block 406, the client retrieves a digital certificate to respond to the server. In one embodiment, block 406 comprises a host processor issuing a request to a memory device to receive a digital certificate. As discussed above, in connection with FIG. 2, this digital certificate can be stored by the memory device prior to the device being released to a customer. In some embodiments, the digital certificate is stored in a write-protected section of memory and thus is tamperproof from external commands. Thus, the host processor receives the digital certificate from the memory device in block 406.

In block 408, the client returns the digital certificate to the server. In alternative embodiments, the certificate can be provided as a part of a Client Certificate message in a TLS session. In some embodiments, the certificate may comprise a single certificate or a certificate chain, as discussed above. As discussed previously, the certificate can include, in a common name field, an identity of a user. For example, the common name field can include an email address, driver's license number, or other personally identified information.

In block 410, the server uses the digital certificate to identify a user account or, in some cases, generate a new user account. In the illustrated embodiment, the digital certificate includes a digital signature. The server can validate the digital certificate by confirming the digital signature using issuing CA's public key. Thus, by confirming the digital certificate with the CA, the server can be assured that the identity of the client in the digital certificate is valid. However, the server will still utilize encryption to ensure that the client device is also in possession of the private key.

Once the server confirms the identity in the digital certificate, the server can identify a corresponding user account in a database of user accounts. For example, the server may maintain a listing of user accounts indexed by email address. Various other details (name, address, etc.) and various other database tables may be stored. The server can extract the email address from the common name field of the digital certificate and can query the listing of user accounts to identify a matching user. If a match is found, the server can generate an authentication token (e.g., a JSON Web Token, cookie, or other session management data structure) for the user to establish a session. The server can then encrypt the authentication token using the public key in the digital certificate to ensure that only the holder of the corresponding private key can decrypt the token. In some scenarios, a user account may not be found when using the common name field. In such a scenario, the server can instead create a new account automatically and then proceed to generate and encrypt an authentication token.

In block 412, the server returns the encrypted authentication token to the user, and in block 414, the client and server communicate over an authenticated session. In the illustrated embodiment, the client receives the authentication token encrypted using the public key provided in the digital certificate. In some embodiments, the host process of the client device can provide the authentication token to the memory device for decryption using the private key stored in a write-protected area of the memory device (or re-generated using a PUF). The host processor can then include this decrypted authentication token in future messages. The host processor can provide these future messages (including the authentication token and the message data) to the memory device for signing using the methods of FIG. 3. For example, the host processor can transmit HTTPS messages, including the authentication token, to the memory device, which can then sign the messages prior to transmitting the secure messages to the server. In this manner, the client can securely communicate with a server without requiring a password or other insecure login mechanism.

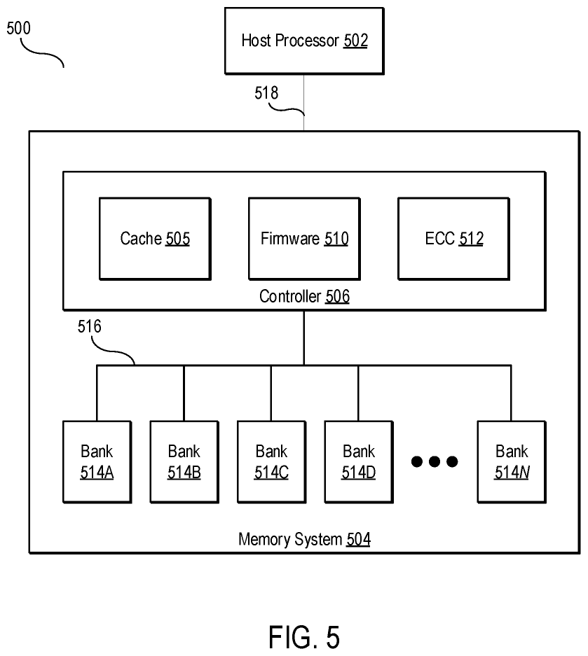

FIG. 5 is a block diagram illustrating a memory system according to some embodiments of the disclosure. Various features of FIG. 5 have been described logically in the description of FIG. 1, and those features are incorporated herein by reference in their entirety.

As illustrated in FIG. 5, a computing system (500) includes a host processor (502) communicatively coupled to a memory system (504) via a bus (518). The memory system (504) comprises a controller (506) communicatively coupled to one or more memory banks (514A-514N), forming a memory array via a bus/interface (516). As illustrated, the controller (506) includes a local cache (505), firmware (510), and an error correction code (ECC) module (512).

In the illustrated embodiment, a host processor (502) can comprise any type of computer processor, e.g., a central processing unit (CPU), graphics processing unit (GPU), or other types of general-purpose or special-purpose computing devices. The host processor (502) includes one or more output ports that allow for the transmission of address, user, and control data between the host processor (502) and the memory system (504). In the illustrated embodiment, this communication is performed over the bus (515). In one embodiment, the bus (518) comprises an input/output (I/O) bus or a similar type of bus.

The memory system (504) is responsible for managing one or more memory banks (514A-514N). In one embodiment, the banks (514A-514N) comprise NAND Flash dies or other configurations of non-volatile memory. In one embodiment, the memory banks (514A-514N) comprise a memory array.

The banks (514A-514N) are managed by the controller (506). In some embodiments, the controller (506) comprises a computing device configured to mediate access to and from banks (514A-514N). In one embodiment, the controller (506) comprises an ASIC or other circuitry installed on a printed circuit board housing the banks (514A-514N). In some embodiments, the controller (506) may be physically separate from the banks (514A-514N). The controller (506) communicates with the banks (514A-514N) over the interface (516). In some embodiments, this interface (516) comprises a physically wired (e.g., traced) interface. In other embodiments, the interface (516) comprises a standard bus for communicating with banks (514A-514N).

The controller (506) comprises various modules (505-512). In one embodiment, the various modules (505-512) comprise various physically distinct modules or circuits. In other embodiments, the modules (505-512) may completely (or partially) be implemented in software or firmware.

As illustrated, firmware (510) comprises the core of the controller and manages all operations of the controller (506). The firmware (510) may implement some or all of the methods described above.

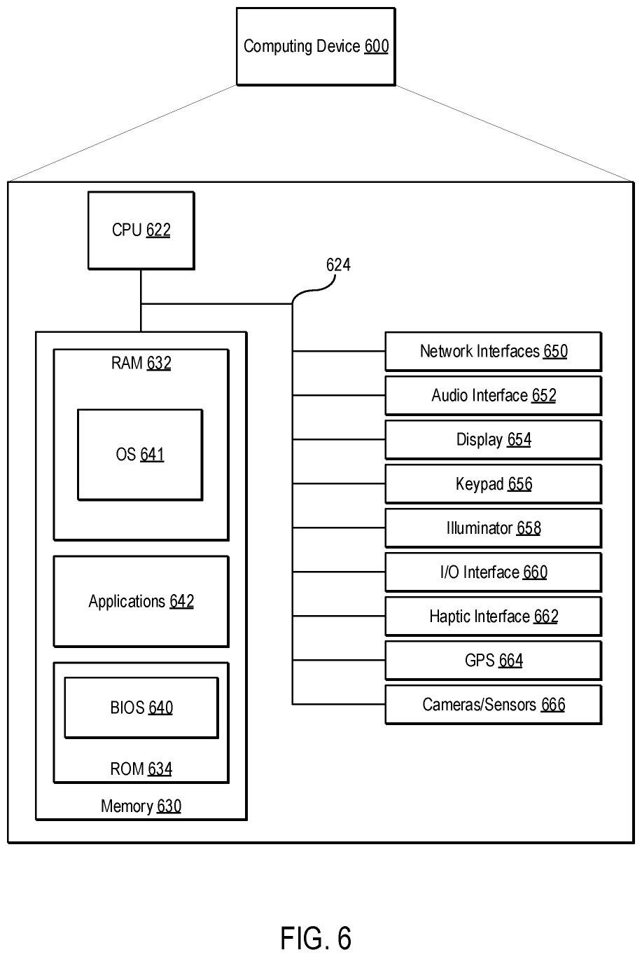

FIG. 6 is a block diagram illustrating a computing device showing an example of a client or server device used in the various embodiments of the disclosure.

The device (600) can include more or fewer components than those shown in FIG. 6, depending on the deployment or usage of the device (600). For example, a server computing device, such as a rack-mounted server, may not include an audio interface (652), display (654), keypad (656), illuminator (658), haptic interface (662), Global Positioning System, GPS receiver (664), or cameras/sensors (666). Some devices can include additional components not shown, such as graphics processing unit (GPU) devices, cryptographic co-processors, artificial intelligence (Al) accelerators, or other peripheral devices.

As shown in the figure, the device (600) includes a central processing unit, CPU (622), in communication with a mass memory (630) via a bus (624). The device (600) also includes a network interface (650), an audio interface (652), a display (654), a keypad (656), an illuminator (658), an input/output interface (660), a haptic interface (662), an optional global positioning systems (GPS) receiver (664) and a camera(s) or other optical, thermal, or electromagnetic sensors (666). Device (600) can include one camera/sensor (666) or a plurality of cameras/sensors (666). The positioning of the camera(s)/sensor(s) (666) on the device (600) can change per device (600) model, per device (600) capabilities, and the like, or some combination thereof.

In some embodiments, the CPU (622) can comprise a general-purpose CPU. The CPU (622) can comprise a single-core or multiple-core CPU. The CPU (622) can comprise a system-on-a-chip (SoC) or a similar embedded system. In some embodiments, a GPU can be used in place of, or in combination with, a CPU (622). Mass memory (630) can comprise a dynamic random-access memory (DRAM) device, a static random-access memory device (SRAM), or a Flash (e.g., NAND Flash) memory device. In some embodiments, mass memory (630) can comprise a combination of such memory types. In one embodiment, the bus (624) can comprise a Peripheral Component Interconnect Express (PCIe) bus. In some embodiments, the bus (624) can comprise multiple busses instead of a single bus.

Mass memory (630) illustrates another example of computer storage media for the storage of information such as computer-readable instructions, data structures, program modules, or other data. Mass memory (630) stores a basic input/output system, BIOS (640), for controlling the low-level operation of the device (600). In the illustrated embodiment, the BIOS (640) may be stored in a read-only memory (ROM) such as ROM (634). The mass memory also stores an operating system (641) for controlling the operation of the device (600).

Applications (642) can include computer-executable instructions which, when executed by the device (600), perform any of the methods (or portions of the methods) described previously in the description of the preceding Figures. In some embodiments, the software or programs implementing the method embodiments can be read from a hard disk drive (not illustrated) and temporarily stored in RAM (632) by CPU (622). CPU (622) can then read the software or data from RAM (632), process them, and store them in RAM (632) again.

The device (600) can optionally communicate with a base station (not shown) or directly with another computing device. Network interface (650) is sometimes known as a transceiver, transceiving device, or network interface card (NIC).

The audio interface (652) produces and receives audio signals such as the sound of a human voice. For example, the audio interface (652) can be coupled to a speaker and microphone (not shown) to enable telecommunication with others or generate an audio acknowledgment for some action. Display (654) can be a liquid crystal display (LCD), gas plasma, light-emitting diode (LED), or any other type of display used with a computing device. Display (654) can also include a touch-sensitive screen arranged to receive input from an object such as a stylus or a digit from a human hand.

Keypad (656) can comprise any input device arranged to receive input from a user. Illuminator (658) can provide a status indication or provide light.

The device (600) also comprises an input/output interface (660) for communicating with external devices, using communication technologies, such as USB, infrared, Bluetooth®, or the like. The haptic interface (662) provides tactile feedback to a user of the client device.

The optional GPS receiver (664) can determine the physical coordinates of the device (600) on the surface of the Earth, which typically outputs a location as latitude and longitude values. GPS receiver (664) can also employ other geo-positioning mechanisms, including, but not limited to, triangulation, assisted GPS (AGPS), E-OTD, CI, SAI, ETA, BSS, or the like, to further determine the physical location of the device (600) on the surface of the Earth. In one embodiment, however, the device (600) can communicate through other components, provide other information that can be employed to determine the physical location of the device, including, for example, a MAC address, IP address, or the like.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to the desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product or software that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as read-only memory (“ROM”), random access memory (“RAM”), magnetic disk storage media, optical storage media, flash memory components, etc.

In this description, various functions and operations are described as being performed by or caused by computer instructions to simplify the description. However, those skilled in the art will recognize what is meant by such expressions is that the functions result from the execution of the computer instructions by one or more controllers or processors, such as a microprocessor. Alternatively, or in combination, the functions and operations can be implemented using special-purpose circuitry, with or without software instructions, such as using Application-Specific Integrated Circuit (ASIC) or Field-Programmable Gate Array (FPGA). Embodiments can be implemented using hardwired circuitry without software instructions or in combination with software instructions. Thus, the techniques are limited neither to any specific combination of hardware circuitry and software nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a physically unclonable function (PUF) configured to generate a unique value; and
firmware, the firmware performing operations of:
receiving a message from a host processor,
loading a private key, the private key generated based on the unique value,
signing the message using the private key to generate a signed message, and
returning the signed message to the host processor.

2. The memory device of claim 1, wherein the firmware further performs the operations of:
generating an asymmetric key pair using the unique value, the asymmetric key pair comprising the private key and a corresponding public key; and
writing the asymmetric key pair to a storage area of the memory device.

3. The memory device of claim 2, wherein the firmware further performs the operations of:
registering the public key with a certificate authority (CA);
receiving a digital certificate from the CA, the digital certificate including a common name (CN) field identifying a user of the memory device; and
writing the CA to the storage area.

4. The memory device of claim 3, wherein the storage area comprises a write-protected storage area.

5. The memory device of claim 1, wherein loading a private key comprises re-generating the private key using the unique value in response to the message.

6. The memory device of claim 1, wherein the firmware further performs the operations of:
receiving a request for a digital certificate from the host processor;
reading the digital certificate from a write-protected storage area, the digital certificate associated with a public key corresponding to the private key and a common name (CN) field identifying a user and used as login information, the public key generated using the unique value; and
returning the digital certificate to the host processor.

7. The memory device of claim 6, wherein the firmware further performs the operations of:
receiving a second message from the host processor, the second message including an authentication token received from a server after logging into the server using the CN field and encrypted using the public key;
decrypting the authentication token to obtain a decrypted authentication token; and
generating a signed message, the signed message generated by signing data, the data including the authentication token.

8. A method comprising:
receiving a message from a host processor;
loading a private key, the private key generated based on a unique value generated by a physically unclonable function (PUF);
signing the message using the private key to generate a signed message, and
returning the signed message to the host processor.

9. The method of claim 8, further comprising:
generating an asymmetric key pair using the unique value, the asymmetric key pair comprising the private key and a corresponding public key; and
writing the asymmetric key pair to a storage area.

10. The method of claim 9, further comprising:
registering the public key with a certificate authority (CA);
receiving a digital certificate from the CA, the digital certificate including a common name (CN) field identifying a user; and
writing the CA to the storage area.

11. The method of claim 10, wherein the storage area comprises a write-protected storage area.

12. The method of claim 8, wherein loading a private key comprises re-generating the private key using the unique value in response to the message.

13. The method of claim 8, further comprising:
receiving a request for a digital certificate from the host processor;
reading the digital certificate from a write-protected storage area, the digital certificate associated with a public key corresponding to the private key and a common name (CN) field identifying a user and used as login information, the public key generated using the unique value; and
returning the digital certificate to the host processor.

14. The method of claim 13, further comprising:
receiving a second message from the host processor, the second message including an authentication token received from a server after logging into the server using the CN field and encrypted using the public key;
decrypting the authentication token to obtain a decrypted authentication token; and
generating a signed message, the signed message generated by signing data, the data including the authentication token.

15. A non-transitory computer-readable storage medium for tangibly storing computer program instructions capable of being executed by a computer processor, the computer program instructions defining steps of:
receiving a message from a host processor;
loading a private key, the private key generated based on a unique value generated by a physically unclonable function (PUF);
signing the message using the private key to generate a signed message, and
returning the signed message to the host processor.

16. The non-transitory computer-readable storage medium of claim 15, the computer program instructions further defining steps of:
generating an asymmetric key pair using the unique value, the asymmetric key pair comprising the private key and a corresponding public key; and
writing the asymmetric key pair to a storage area.

17. The non-transitory computer-readable storage medium of claim 16, the computer program instructions further defining steps of:
registering the public key with a certificate authority (CA);
receiving a digital certificate from the CA, the digital certificate including a common name (CN) field identifying a user; and
writing the CA to the storage area.

18. The non-transitory computer-readable storage medium of claim 15, wherein loading a private key comprises re-generating the private key using the unique value in response to the message.

19. The non-transitory computer-readable storage medium of claim 15, the computer program instructions further defining steps of:
receiving a request for a digital certificate from the host processor;
reading the digital certificate from a write-protected storage area, the digital certificate associated with a public key corresponding to the private key and a common name (CN) field identifying a user and used as login information, the public key generated using the unique value; and
returning the digital certificate to the host processor.

20. The non-transitory computer-readable storage medium of claim 19, the computer program instructions further defining steps of:
receiving a second message from the host processor, the second message including an authentication token received from a server after logging into the server using the CN field and encrypted using the public key;
decrypting the authentication token to obtain a decrypted authentication token; and
generating a signed message, the signed message generated by signing data, the data including the authentication token.
